(19) United States
(12) Patent Application Publication
(10) Pub. No.: US 2010/0029471 A1
(43) Pub. Date: Feb. 4, 2010

(54) Photocatalyst-synthesized fiber product

(76) Inventor: Ruei-Shan Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/588,220

(22) Filed: Oct. 8, 2009

Related U.S. Application Data
(63) Continuation-in-part of application No. 11/604,384, filed on Nov. 27, 2006.

(51) Int. Cl. B01J 31/06; B01J 31/02

(52) U.S. Cl. 502/159; 502/150

(57) ABSTRACT

A photocatalyst-synthesized fiber product includes a base material, and a plurality of photocatalyst naps. The photocatalyst naps are firmly pasted on a surface of the base material. By uniformly and densely disposing the photocatalyst naps on the surface of the base material, the area of the base material disposed by photocatalyst increases so as to increase the effect of the photocatalyst. Furthermore, due to the photocatalyst naps being attached to a surface of the base material, the color of the surface of the base material is unaffected.

### CROSS REFERENCE TO RELATED APPLICATION

This application is a continuation-in-part of U.S. application Ser. No. 11/604,384, filed on 27 Nov. 2006 and entitled “a photocatalyst synthesized fiber product”, now pending.

### BACKGROUND OF THE INVENTION

1. Field of the Invention

The present invention relates to a photocatalyst-synthesized fiber product. In particular, this invention relates to a photocatalyst-synthesized fiber product with a photocatalyst nap.

2. Description of the Related Art

As industry and technology have developed, living standards have substantially improved. However, the environment has also become polluted through the development of industry and technology. Photocatalyst technology can deal with chloride-benzene organic materials, chloride-phenol compounds, cyanide, and the metal ions in water, and NOₓ, SOₓ in air. In the photocatalyst reaction process, the photocatalyst is a catalytic agent and is not consumed. Therefore, the photocatalyst is suitable for purifying air and water, deodorizing, disinfecting, and protecting household environments from dirt.

In a household, window curtains are installed to keep external light at bay. However, the window curtains directly contact the air. In order to remove pollutants from the air, an air conditioner with a photocatalyst is often installed in the household. Alternatively, the photocatalyst can be disposed on the window curtains. There are two kinds of photocatalyst window curtains. One kind allows the spraying of water including the photocatalyst on the window curtain cloth. However, the photocatalyst is not easily attached to the window curtain cloth, and the quantity of the photocatalyst attached to the window curtain cloth is small and unbalanced. Therefore, the functions of the photocatalyst, such as decomposing pollutions, deodorizing, and disinfecting, are not as efficient as they could be. The second method soaks the window curtain cloth in the photocatalyst solution to fully dispose the photocatalyst on the window curtain cloth. The result is better however, the photocatalyst easily drips off the window curtain cloth, and the color of the soaked window curtain cloth deteriorates.

As shown in the Kimura et al. (U.S. Pat. No. 6,228,480), that invention provides a photocatalyst-carrying structure wherein an adhesive layer is provided between a photocatalyst layer and a substrate. However, it seems that the surface of the photocatalyst layer lacks the movability and the area which the photocatalyst layer contact with the environment is limited.

As shown in the Park et al. (US Application No. 2005/0133863), that invention provides a sterilizing comb for pets includes a case, a plurality of bristles attached on the case and a sterilizer. Photocatalyst is applied on the bristles. However, the bristle needs to be stiff in certain degree so that it would be applicable to brushing the fur of the pet. It is easily understand that the stiffness of the bristles makes the bristles not easily applied to other field of the photocatalyst relative product.

### SUMMARY OF THE INVENTION

One particular aspect of the present invention is to provide a photocatalyst-synthesized fiber product. The photocatalyst-synthesized fiber is attached firmly, uniformly, and densely on the surface of the photocatalyst-synthesized fiber product. The color of the photocatalyst-synthesized fiber product remains unaffected. The area upon which the photocatalyst is disposed increases so as to increase the effect of the photocatalyst.

The photocatalyst-synthesized fiber product includes a base material, and a plurality of photocatalyst naps. The photocatalyst naps are pasted on a surface of the base material. On the naps of the photocatalyst naps, the photocatalyst is fully disposed. The photocatalyst of the photocatalyst naps is firmly disposed on the surface of the naps, and the photocatalyst naps are firmly pasted on the base material and are uniformly and densely disposed on the base material. The color of the base material is unaffected by the naps. The photocatalyst naps increase the area of the photocatalyst reaction to enhance the function of the photocatalyst.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide further understanding of the invention. A brief introduction of the drawings is as follows:

FIG. 1 is a schematic diagram of the photocatalyst-synthesized fiber product of the present invention;

FIG. 2 is a schematic diagram of the photocatalyst nap of the present invention;

FIG. 3 is a schematic diagram of the first embodiment of the present invention;

FIG. 4 is a schematic diagram of the second embodiment of the present invention;

FIG. 5 is a schematic diagram of the third embodiment of the present invention;

FIG. 6 is a schematic diagram of the fourth embodiment of the present invention;

FIG. 7 is a perspective view of the fourth embodiment of the present invention; and

FIG. 8 is a partial enlargement view of the FIG. 7.

### DETAILED DESCRIPTION OF THE PREFERRED EMBODIMENTS

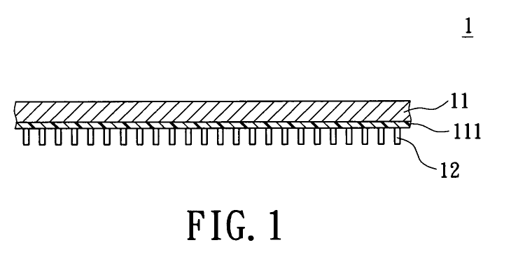

Reference is made to FIG. 1. The photocatalyst-synthesized fiber product 1 includes a base material 11, and a plurality of photocatalyst naps 12. The photocatalyst naps 12 are uniformly and densely adhered on the base material 11. On the surface of the base material 11′, an adhesive layer 111 is coated to firmly paste the photocatalyst naps 12 on the surface of the base material 11.

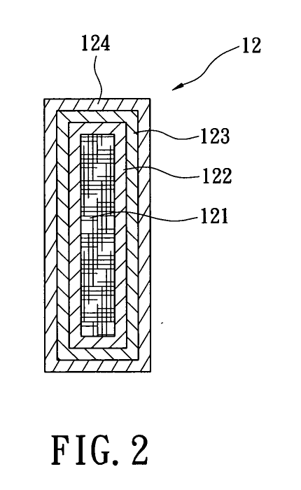

Reference is made to FIG. 2. The photocatalyst nap 12 includes a nap 121, a layer of mixing agent which is mixed with antistatic agent and dispersant 122, a layer of crosslinking agent 123, and a layer of photocatalyst 124. The nap 121 can be a synthesized fiber, such as, for example, nylon fiber, Dacron (polyethylene terephthalate) fiber or acrylic, or a compound fiber that is a combination of the synthesized fiber and natural fiber, such as, for example, wool fiber or cotton fiber. The mixing agent mixed by antistatic agent and dispersant 122 attaches to the surface of the nap 121. The crosslinking agent 123 is disposed on an outside of the mixing agent mixed by antistatic agent and dispersant 122 and disposed on the surface of the nap 121. The photocatalyst 124 is disposed on the crosslinking agent 123 and disposed on the surface of the nap 121. The crosslinking agent 123 is firmly combined with the mixing agent mixed by antistatic agent and dispersant 122 and the photocatalyst 124. Therefore, the photocatalyst 124 is firmly attached to the naps so that the layer of the photocatalyst 124 is firmly attached on the surface of the photocatalyst naps 12.

The photocatalyst naps 12 are attached to a surface of the base material 11. Therefore, another surface of the base material 11 maintains its original appearance and is unaffected by the photocatalyst. The photocatalyst naps 12 makes the area of the base material 11 disposed by the photocatalyst naps 12 increase. Therefore, the reaction area of the photocatalyst 124 increases to enhance the function of the photocatalyst 124. The photocatalyst-synthesized fiber is firmly attached to the surface of the photocatalyst-synthesized fiber product 1, and is uniformly and densely disposed. The original color of the photocatalyst-synthesized fiber product 1 is unaffected, and the reaction area of the photocatalyst 124 increases so as to enhance the function of the photocatalyst 124. Referring to FIGS. 1 and 2, although the photocatalyst naps 12 protrude perpendicularly from the said base material 11, which means the bottom of the photocatalyst naps 12 are perpendicular to the base material 11, the naps 121 may be a soft material such that the middle portion of the photocatalyst naps 12 would be bent. In that way, not only are the photocatalyst naps 12 easily arranged on the base material 11 but also the photocatalyst naps 12 have some degree of softness to make the user much more comfortable to contact with.

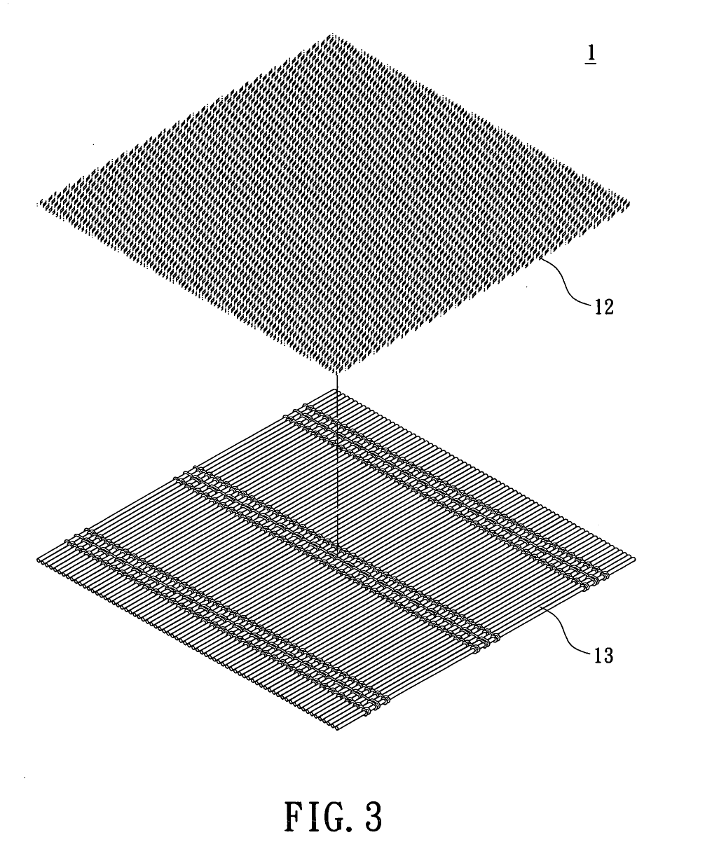

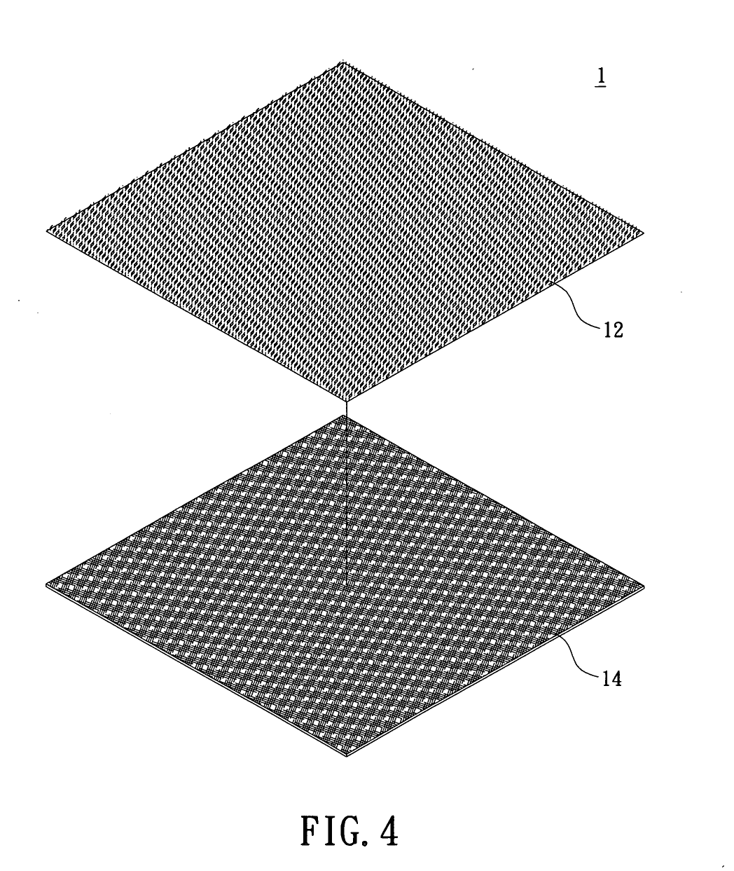

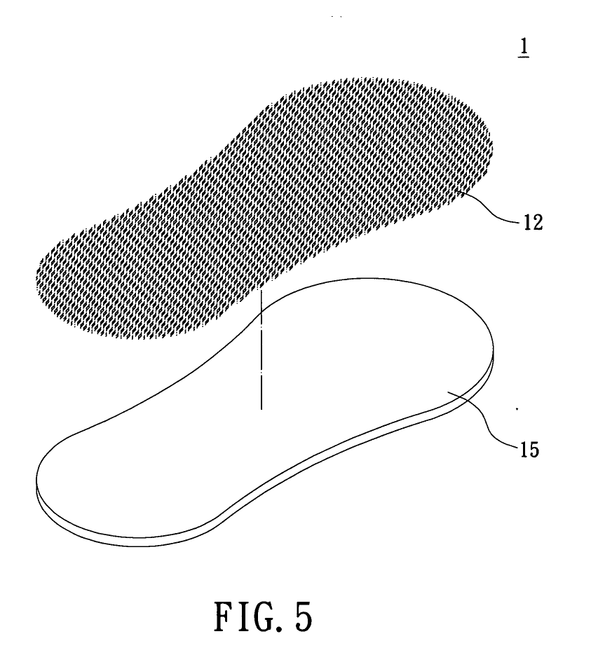

The photocatalyst-synthesized fiber product 1 can be applied in many aspects, such as shown in FIGS. 3, 4 and 5. The base material 11 can be a bamboo curtain 13, a car sunshade pad 14, or a shoe pad 15, and is uniformly and densely disposed via a plurality of photocatalyst pads 12. Thereby, the bamboo curtain 13, the car sunshade pad 14, and the shoe pad 15 achieve the functions of the photocatalyst—including purifying air and water, as well as deodorizing and disinfecting the nearby environment. The photocatalyst-synthesized fiber product 1 can also be applied to other common surfaces, such as window curtains, masks, etc. Because only one surface of the photocatalyst-synthesized fiber product 1 is attached by the photocatalyst naps 12, it is more suitable for products having an outer surface and an inner surface, such as shoes or clothes. Therefore, the photocatalyst-synthesized fiber product 1 can be extensively applied to everyday products to clean and comfort our daily life.

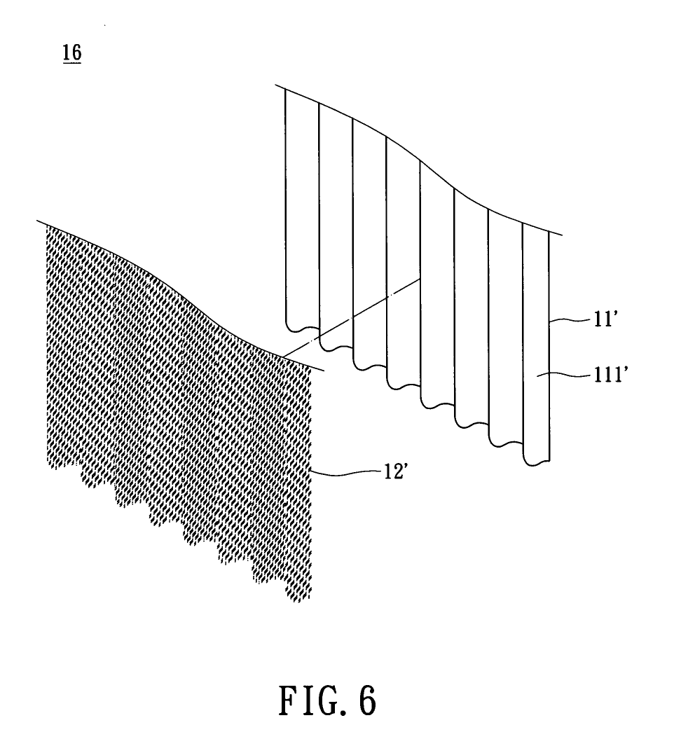

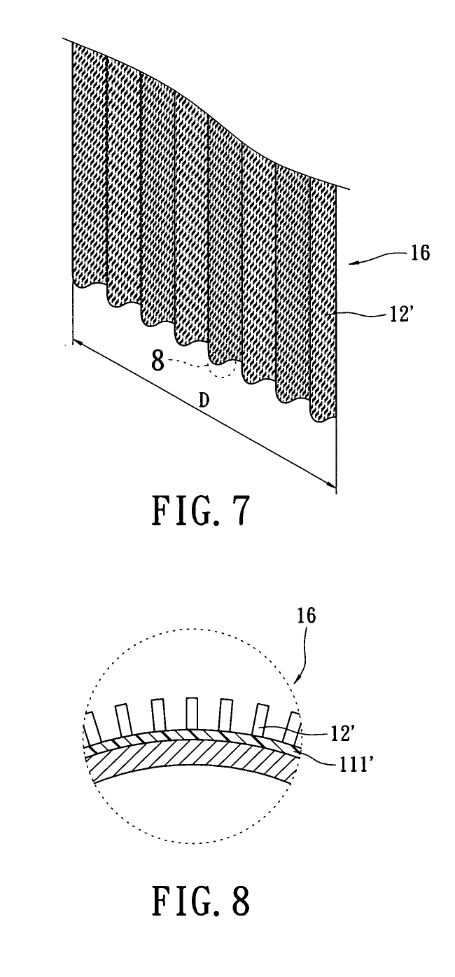

As shown in FIGS. 6, 7, and 8, it is the fourth embodiment of the present invention. Here it is specifically pointed out a curtain 16 that is another type of the photocatalyst-synthesized fiber product 1. The curtain 16 comprises a base material 11′, and a plurality of photocatalyst naps 12′. The photocatalyst naps 12′ are uniformly and densely adhered on the base material 11′. On the surface of the base material 11′, an adhesive layer 111′ is coated to firmly paste the photocatalyst naps 12′ on the surface of the base material 11′.

In this embodiment, the base material 11′ can be referred as a backbone of the present invention. The base material 11′ is not flat but rather a wave-like shape. Concurrently, the photocatalyst naps 12′ attaching on the base material 11′ would also be a wave-like shape or form. The bottom of each of the photocatalyst nap 12′ is perpendicular to the base material 11′, no matter how the base material 11′ change. Since the base material is wave-like shape, it would have higher density in a distance D than other base materials which present as a plate-like shape or form.

The description above illustrates only specific embodiments and examples of the invention. The invention therefore encompasses modifications and variations made to the herein-described structure and operations of the invention, provided they fall within the scope of the invention as defined in the following appended claims, which provide the only complete description of this invention.

What is claimed is:

1. A photocatalyst-synthesized fiber product, comprising:
a base material; and
a plurality of photocatalyst naps are adhered on a surface of the base material, wherein each of the photocatalyst naps comprises a nap, said nap having a layer of mixing agent, a layer of crosslinking agent, and a layer of photocatalyst;
wherein said mixing agent comprises an antistatic agent and a dispersant;
wherein said layer of mixing agent is disposed on said nap, said layer of crosslinking agent is disposed on said layer of mixing agent, and said layer of photocatalyst is disposed on said crosslinking agent and attached to a surface of said base material; and
wherein said photocatalyst naps protrude perpendicularly from said base material.

2. The photocatalyst-synthesized fiber product as claimed in claim 1, wherein the surface of the base material pasted by the photocatalyst naps is coated with an adhesive agent, and the photocatalyst naps are pasted on the adhesive agent.

3. The photocatalyst-synthesized fiber product as claimed in claim 1, wherein the base material is a bamboo curtain, a car sunshade pad, a shoe pad, a window curtain cloth, or a mask.

4. The photocatalyst-synthesized fiber product as claimed in claim 1, wherein the nap is a synthesized fiber.

5. The photocatalyst-synthesized fiber product as claimed in claim 4, wherein the synthesized fiber is made from nylon fiber, polyethylene terephthalate fiber or acrylic fiber.

6. The photocatalyst-synthesized fiber product as claimed in claim 1, wherein the nap is a compound fiber.

7. The photocatalyst-synthesized fiber product as claimed in claim 6, wherein the compound fiber is composed of natural fiber and synthesized fiber.

8. The photocatalyst-synthesized fiber product as claimed in claim 7, wherein the natural fiber is wool fiber or cotton fiber, and the synthesized fiber is nylon fiber, polyethylene terephthalate or acrylic fiber.

9. A photocatalyst-synthesized curtain, comprising:
a base material; and
a plurality of photocatalyst naps pasted on a surface of the base material, wherein each of the photocatalyst naps comprises a nap, said nap having a layer of mixing agent, a layer of crosslinking agent, and a layer of photocatalyst;
wherein said mixing agent comprises an antistatic agent and a dispersant;
wherein said layer of mixing agent is disposed on said nap, said layer of crosslinking agent is disposed on said layer of mixing agent, and said layer of photocatalyst is disposed on said crosslinking agent and attached to a surface of said base material; and
wherein said photocatalyst naps protrude perpendicularly from said base material.

10. The photocatalyst-synthesized fiber curtain as claimed in claim 9, wherein the base material is wave-like.

11. The photocatalyst-synthesized fiber curtain as claimed in claim 9, wherein bottom of the photocatalyst naps protrude perpendicularly from said base material.
